(19) United States
(12) Patent Application Publication
(10) Pub. No.: US 2010/0078376 A1
(43) Pub. Date: Apr. 1, 2010

(54) DEWATERING STRUCTURE

(76) Inventor: Tsung Mou Yu, Taipei (TW)

Correspondence Address: Muncy, Geissler, Olds & Lowe, PLLC, P.O. BOX 1364, FAIRFAX, VA, 22038-1364, US

(21) Appl. No.: 12/477,331

(22) Filed: Jun. 3, 2009

(30) Foreign Application Priority Data
Oct. 1, 2008 (TW) 097217619

(51) Int. Cl. C02F 11/12

(52) U.S. Cl. 210/236

(57) ABSTRACT

A dewatering structure is provided. The dewatering structure includes a receptacle body, a dewatering unit, and an operation unit. The receptacle body includes a receptacle tub and an assembling space. The dewatering unit is a hollow bucket which allows fluid flowing therethrough. The dewatering unit is assembled in the receptacle tub. The operation unit includes an operation member, a base, and a transmission mechanism. The operation member is pivotally connected to the base, and is adapted for swinging like a teeterboard at the pivotal position thereof as a pivotal axis. An elastic member is disposed between the operation member and the base, and provides an upward elastic force to the operation member. The transmission mechanism includes a gear assembly and a transmission shaft. The gear assembly includes an in-line gear disk and an irreversible driving gear disk. The in-line gear disk is pivotally coupled to the supporting bracket of the base.

### BACKGROUND OF THE INVENTION

1. Field of the Invention

The present invention relates generally to a dewatering structure, and more particularly, to an electricity-free dewatering structure adapted for dewatering a water-contained object by applying a centrifugal force.

2. The Prior Arts

Water is the best detergent and solvent in nature. Water is used for wetting dusts and debris, and solving dirt, thus for cleaning the living environment or furniture. In general, except those humidity sensitive objects required to be cleaned with a dry fabric, ordinary objects are often cleaned by a fabric containing a certain water therein.

Mopping the floor is a routine job that has to be done everyday. In general, a cloth sheet contained with water can be used to clean the floor. More often, different types of mops are used to mop the floor. However, any cloth sheet or a mop used for cleaning the floor has to be repetitively flushed by water for removing dusts or dirt from the cloth sheet or the mop, and they have to be dewatered to a suitable water content therein for next cleaning. The cloth sheet usually has to be dewatered by wringing with hands or by a centrifugal drier. However, a mop typically includes a mop cloth and a rod. Such a mop cannot be put inside a centrifugal drier for removing the water therefrom. Further, it is also inconvenient and laborious to wring the cloth sheet or the mop cloth. Moreover, when wringing the cloth sheet or the mop cloth with hands to remove the water, one may put his/her hands and/or skin in the risk of being hurt by the dusts, and dirt carried therein.

An improved conventional mop is further equipped with a set of clamping rollers at a rod of the mop. The clamping rollers are adapted for squeezing out the water from the mop cloth. This improvement allows the user not to directly touch the mop cloth with hands. However, it introduces additional disadvantages. Firstly, the clamping rollers are mounted on the mop, thereby increasing the volume of the mop. Secondly, the clamping rollers can be used for dewatering one mop only, and cannot be used to dewater other mops or cloth sheets. Further, the clamping rollers inevitably increases the manufacturing cost of the mop, and thus would be sold with a higher price.

A conventional wringer bucket for a mop has been proposed for dewatering a variety of mop cloths. The wringer bucket employs a roller drum for squeezing the cloth of the mop and removing the water contained therein, so as to dewatering the mop. However, conventional disk type mops and rotary disk type mops which cloths are relatively short and are distributed beneath the disks or the rotary disks cannot be dewatered with the conventional wringer bucket.

Taiwanese Patent Publication No. M338634 discloses a dewatering apparatus as shown in FIGS. 1 and 2. Referring to FIGS. 1 and 2, the dewatering apparatus is directed to provide a solution to the dewatering difficulty of the foregoing rotary disk type mops. The dewatering apparatus includes a receptacle body 100, a rotary unit 200, a transmission unit 300, and a driving rod unit 400. In operation, a cloth 501 of a rotary disk type mop 500 is disposed in a bucket 201 of the rotary unit 200. The driving rod unit 400 drives the transmission unit 300 and the rotary unit 200, so as to dewatering the cloth 501 disposed in the bucket 201. Although the dewatering apparatus disclosed in Taiwanese Patent Publication No. M338634 can dewater the cloth 501 of the rotary disk type mop 500, the structure thereof has the following disadvantages:

(1) When the driving rod unit 400 is applied by a force, the structure of the dewatering apparatus appears insufficient stability problems of displacement and jumpiness. The driving rod unit 400 includes a driving rod 401. An upper end of the driving rod 401 is pivotally connected with a shaft rod 101. The driving rod 401 is adapted for driving the transmission unit 300 by applying a leftward pivot force relative to the shaft rod 101. When the driving rod 401 applies a leftward pivot force, the whole structure of the dewatering apparatus will be leftward moved. When the repetitive forces are applied thereon, the whole structure will then be driven to appear intermittent, leftward jumping displacements, and thus be difficult to be maintained at the original position. This may cause the driving rod 401 of the driving rod unit 400 unable to stably work or apply forces to and fro;

(2) It appears transmission non-smooth, acceleration difficult, and an insufficient centrifugal force. The mop cloth 501 of the rotary disk type mop 500 is dewatered by the centrifugal force of the rotary unit 200. As such, only when the bucket 201 is accelerated to a certain rotation speed, the centrifugal force of the rotary unit 200 can be afforded to sufficiently dewater the mop cloth 501. However, the driving rod 401 of the driving rod unit 400 is incapable of stably working or applying forces to and fro, so that it is difficult to smoothly drive the gear rack 301 to horizontally move so as to drive an in-line gear 302 and a one-way gear 303. As such, it is hard to further improve the rotation speed of the rotary unit 200 driven by the transmission unit 300;

(3) Because the whole structure of the dewatering apparatus intermittently and leftward jumpily displaces, the mop cloth 501 of the rotary disk type mop 500 cannot be stably positioned at a center of the bucket 201 of the rotary unit 200. Therefore, the bucket 201 may be caused with vibration, which deters the rotation; and

(4) The receptacle body 100 is provided with rollers 102 thereunder. Although convenient for moving, the rollers 102 unfortunately make the whole structure more unstable when applied with the leftward force by the driving rod 401.

In view of the aforementioned disadvantages of the dewatering apparatus disclosed in Taiwanese Patent Publication No. M338634, it can be learnt that when dewatering by the centrifugal force, the whole structure must be maintained stable and the transmission should be smooth, so that the rotary unit should be stably accelerated to a certain rotation speed.

### SUMMARY OF THE INVENTION

A primary objective of the present invention is to provide an electricity-free dewatering structure. The dewatering structure is adapted for dewatering a cloth sheet or a variety of cloths. The dewatering structure also provides a solution to the problems of the aforementioned conventional dewatering structure.

For achieving the foregoing objectives, the present invention provides a dewatering structure. The dewatering structure includes a receptacle body, a dewatering unit, and an operation unit. The receptacle body includes a receptacle tub and an assembling space. The dewatering unit is a hollow bucket which allows fluid flowing therethrough. The dewatering unit is assembled in the receptacle tub. The operation unit includes an operation member, a base, and a transmission mechanism. The operation member is pivotally coupled to the base, and the operation member is allowed to swing like a teeterboard at the pivotal position thereof as a pivotal axis. The operation member has an operation end. The operation end is assembled with an elastic member. The elastic member provides an upward elastic force to the operation end of the operation member. Another end of the operation member is provided with a fan shaped gear rack. The transmission mechanism includes a gear assembly and a transmission shaft. The gear assembly includes at least one in-line gear disk and an irreversible driving gear disk. The in-line gear disk meshes with the irreversible driving gear disk. The in-line gear disk meshes with the fan shaped gear rack of the operation member. The transmission shaft is assembled with the irreversible driving gear disk, and an upper end of the transmission shaft passes through a bottom of the receptacle tub for assembling with the dewatering unit.

The present invention provides a dewatering structure. When operating such a dewatering structure, a user repetitively applies a force on and releases it from an operation member of an operation unit, alternatively. Therefore, the gear rack then drives the gear assembly and the transmission shaft to remain the dewatering unit in rotation or be accelerated. In such a way, water contained objects disposed in the dewatering unit can be dewatered by a centrifugal force.

The present invention provides a dewatering structure. The operation unit is adapted for applying a force along a direction substantially perpendicular to the ground, thus eliminating the problem of a moment applied thereon. As such, the dewatering structure is stabilized, in its entirety, at where it is. When such a dewatering structure is repetitively applied with external forces, it won't jump or move, or even fall down.

The present invention provides an electricity-free dewatering structure which can be manufactured with a low cost for satisfying the demands of power saving and environmental protection

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a partial exploded view of a dewatering apparatus disclosed in Taiwanese Patent Publication No. M338634;

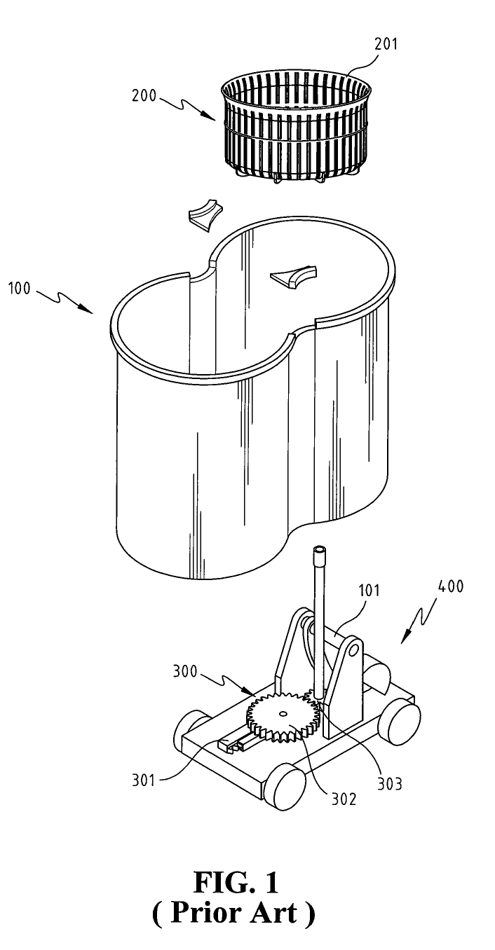

FIG. 2 is a cross-sectional view of the dewatering apparatus disclosed in Taiwanese Patent Publication No. M338634;

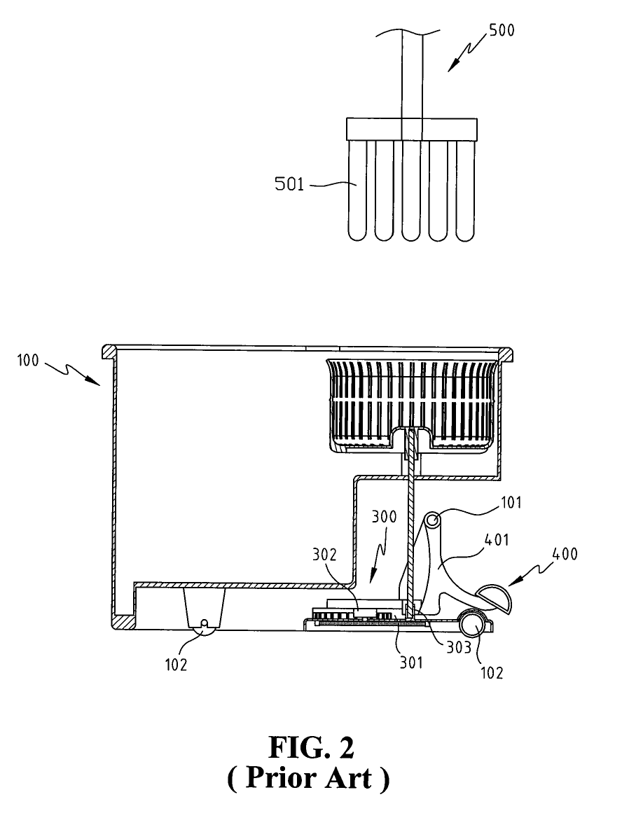

FIG. 3 is a perspective view of a dewatering structure according to an embodiment of the present invention;

FIG. 4 is an exploded view of the dewatering structure of the present invention;

FIG. 5 is a detailed exploded view illustrating an operation unit of the dewatering structure of the present invention;

FIG. 6 is a cross-sectional view of the dewatering structure of the present invention;

FIG. 7 is a cross-sectional view illustrating an operation when the operation unit is applied by an external force F according to an embodiment of the present invention; and

FIG. 8 illustrates a subsequent operation state after releasing the applied external force F.

FIG. 9 is a cross-sectional view of a dewatering structure according to a second embodiment of the present invention;

FIG. 10 is a cross-sectional view illustrating an operation when the operation unit is applied by an external force F according to the second embodiment of the present invention; and

FIG. 11 illustrates a subsequent operation state after releasing the applied external force of FIG. 10.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

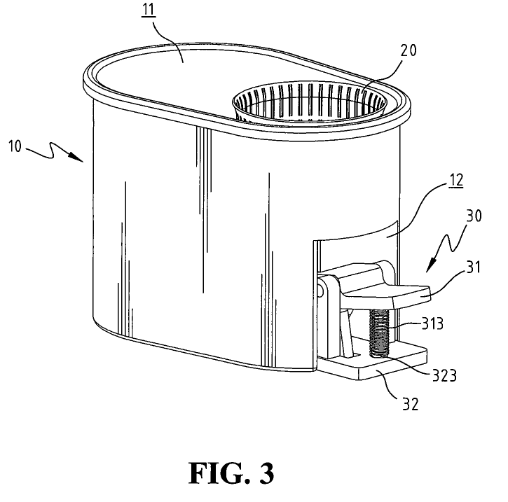

Referring to FIGS. 3, 4, 5, and 6, there are shown a perspective view, an exploded view, a detailed exploded view illustrating an operation unit, and a cross-sectional view of a dewatering structure according to an embodiment of the present invention. The dewatering structure includes a receptacle body 10, a dewatering unit 20, and an operation unit 30.

The receptacle body 10 is substantially configured to a hollow elliptical column shape, and includes a receptacle tub 11 and an assembling space 12. The receptacle tub 11 and the assembling space 12 are partitioned by a water proofing material into two independent spaces. The receptacle tub 11 is adapted for containing fluid. Typically, the fluid can be water or water solution. The assembling space 12 is defined beneath the receptacle tub 11.

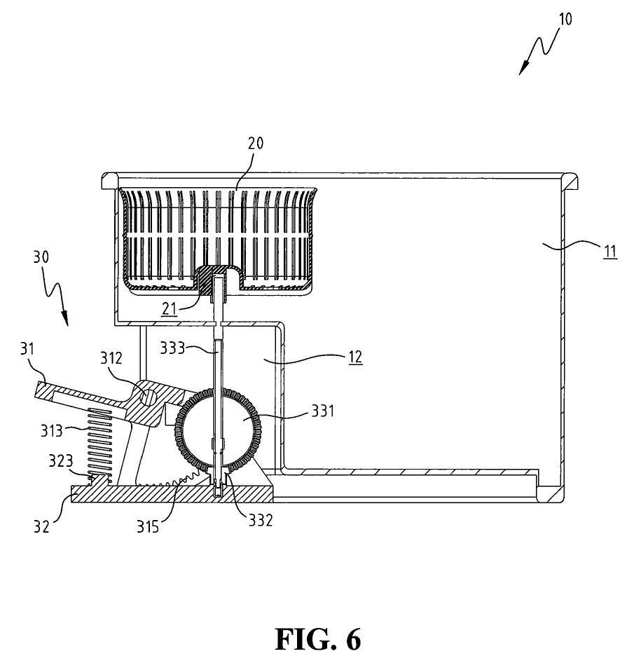

The dewatering unit 20 is a hollow bucket allowing fluid flowing therethrough. The dewatering unit 20 is disposed in the receptacle tub 11. An assembling hole 21 is defined at a barycenter of a bottom of the receptacle tub 11, as shown in FIG. 6.

The operation unit 30 includes an operation member 31, a base 32, and a transmission mechanism 33.

The operation member 31 includes an operation end. The operation end is substantially configured to a treadle shape. The operation member 31 is defined with a pivotal hole 311, and is pivotally coupled to the base 32 by a pin 312. The operation member 31 is allowed to swing like a teeterboard relative to the pin 312 at the pivotal position. An elastic member 313 is provided between the operation end and the base 32. The elastic member 313 provides an upward elastic force to the operation end of the operation member 31. Another end of the operation member 31 is coupled with a hollow fan plate 314. The hollow fan plate 314 has an inner arcuate surface configured with an arcuate gear rack 315. In the current embodiment, the elastic member 313 is preferred to be a coil spring.

The base 32 includes two supporting seats 321. Each of the two supporting seats 321 is defined with a pivotal hole 3211 corresponding to the pivotal hole 311 of the operation member 31. A pin 312 is inserted through the pivotal holes 3211 and the pivotal hole 311 of the operation member 31, thus pivotally fixing the operation member 31 to the base 32. In such a way, the operation member 31 is allowed to swing like a teeterboard relative to the pin 312 at the pivotal position thereof as a pivotal axis. The base 32 is further provided with at least one supporting bracket 322 defined with a shaft hole 3221. The base 32 is further provided with a positioning pole 323 and a shaft hole 324 at a bottom thereof. The elastic member 313 of the operation member 31 is sleeved on the positioning pole 323, so as to prevent the lower side of the elastic member 313 from sliding or displacement.

The transmission mechanism 33 includes a gear assembly and a transmission shaft 333. The gear assembly includes at least one in-line gear disk 331 and an irreversible driving gear disk 332. The in-line gear disk 331 is pivotally coupled to the shaft hole 3221 of the supporting bracket 322. The in-line gear disk 331 includes a pinion 3311 provided in a hollow section of the hollow fan plate 314 and meshing with the arcuate gear rack 315. The gear plate of the in-line gear disk 331 meshes with the irreversible driving gear disk 332. In the current embodiment, the in-line gear disk 331 perpendicularly meshes with the irreversible driving gear disk 332. The transmission shaft 333 is assembled to the irreversible driving gear disk 332. A lower end of the transmission shaft 333 is movably embedded in the shaft hole 324 at the bottom surface of the base 32. An upper end of the transmission shaft 333 passes through the bottom of the receptacle tub 11, and is thus assembled with the assembling hole 21 defined at a bottom of the dewatering unit 20.

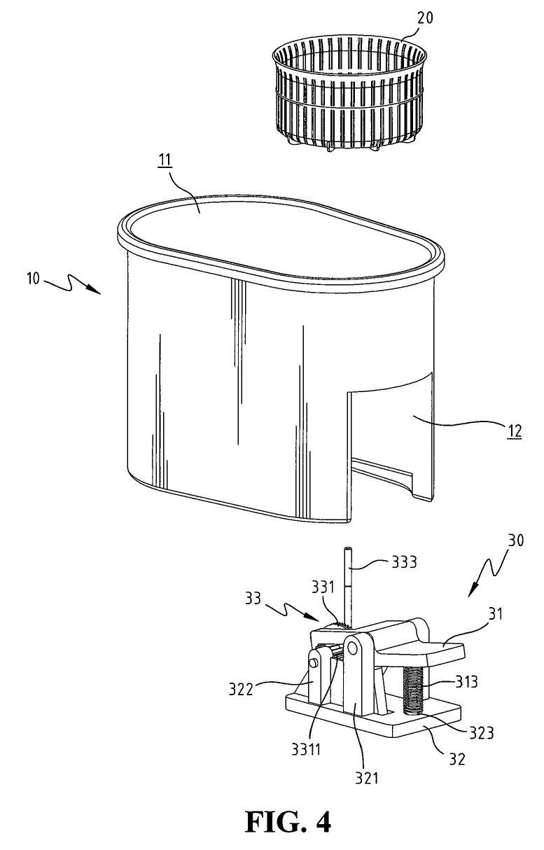

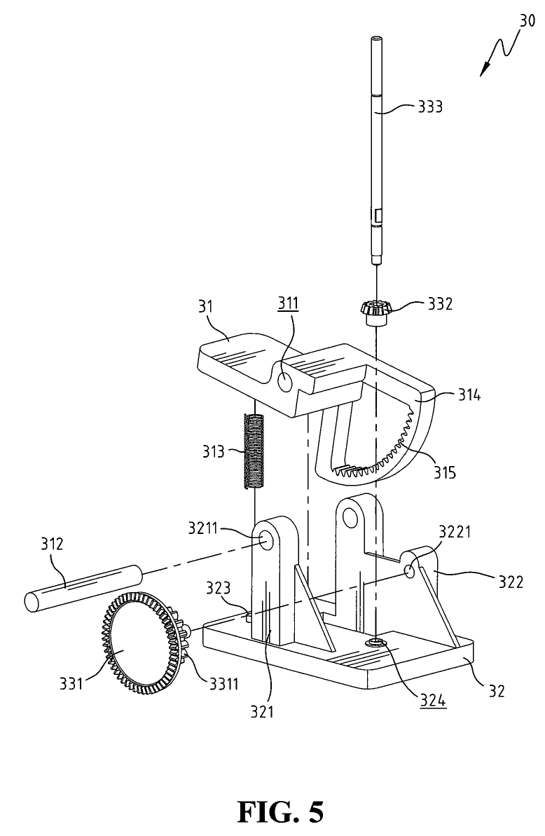

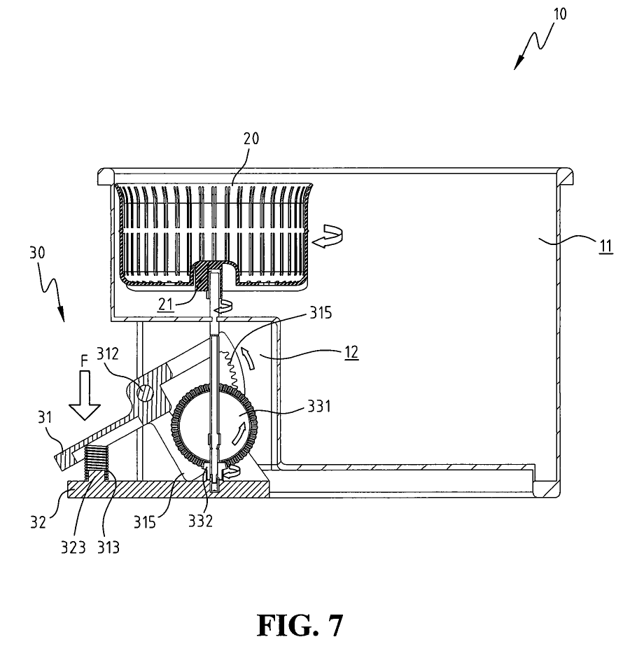

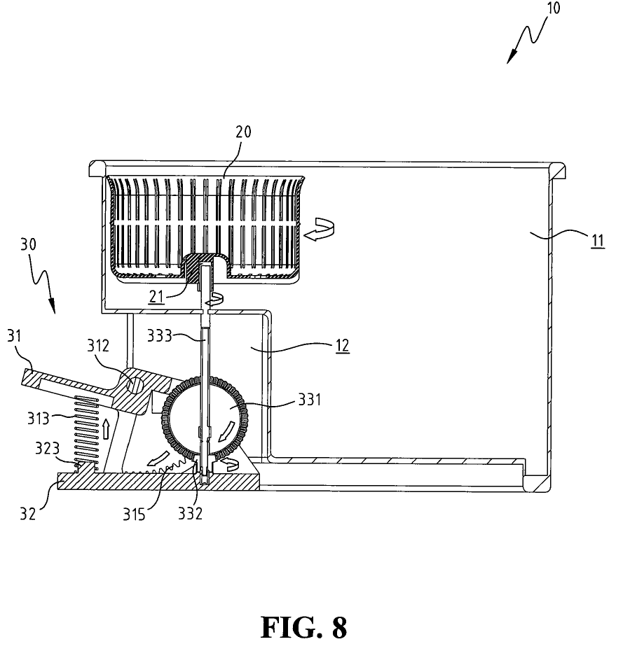

FIG. 6 describes a state of the dewatering structure when there is no external force applied thereto. FIG. 7 describes an operation state of the dewatering structure when an external force F is applied thereto. FIG. 8 illustrates a state after releasing the applied external force F. Referring to FIG. 6, in accordance with the state of the dewatering structure, the operation member 31 is propped up and maintained at a high position by the elastic member 313. As shown in FIG. 7, when a user downwardly applies an external force F onto the operation member 31, the operation end of the operation member 31 swings pivotally downwardly relative to the pin 312 and thus moves to a low position. Meanwhile, the arcuate gear rack 315 of the operation member 31 swings upwardly to drive the pinion 3311 (as shown in FIGS. 4 and 5) and the in-line gear disk 331 to synchronously rotate in counterclockwise direction. Therefore, the in-line gear disk 331 drives the irreversible driving gear disk 332, the transmission shaft 333 and the dewatering unit 20 to rotate in clockwise direction, as shown in FIG. 7. In such a way, as being downwardly compressed by the downwardly swung operation end of the operation member 31, the elastic member 313 accumulates an elastic recovery force. Referring to FIG. 8, when the external force F applied to the operation member 31 is released therefrom, the accumulated elastic recovery force then pushes the elastic member 313 up back to the high position. In this case, the operation end of the operation member 31 swings upwardly, while the arcuate gear rack 315 at the other end of the operation member 31 swings downwardly, thus driving the pinion 3311 and the in-line gear disk 331 to synchronously rotate in clockwise direction. Meanwhile, the in-line gear disk 331 also drives the irreversible driving gear disk 332 to rotate in counterclockwise direction. The irreversible driving gear disk 332 can drive the transmission shaft 333 to rotate in one way (clockwise) only, and therefore the transmission shaft 333 and the dewatering unit 20 remain to rotate in clockwise direction due to its inertia.

The present invention alternatively and repetitively applies and releases the external force F (releasing the operation end of the operation member 31), so as to utilize the arcuate gear rack 315 of the operation unit 30 to drive the in-line gear disk 331, the irreversible driving gear disk 332 and the transmission shaft 333, thus driving the dewatering unit 20 to remain in rotation or be accelerated.

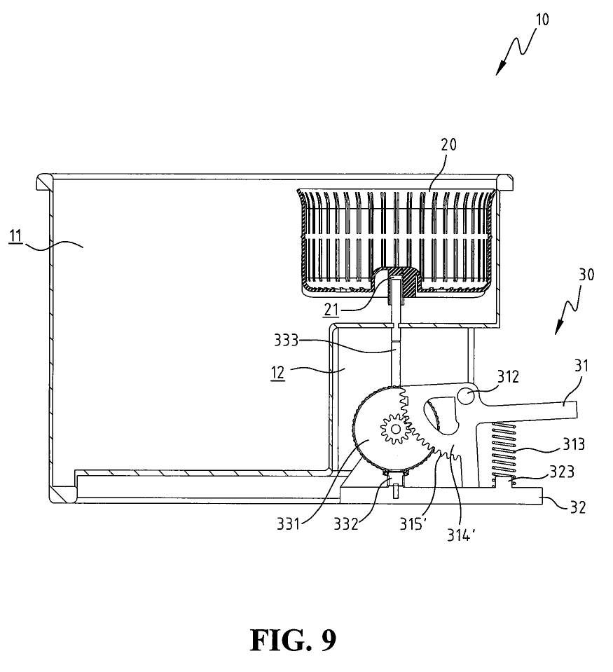

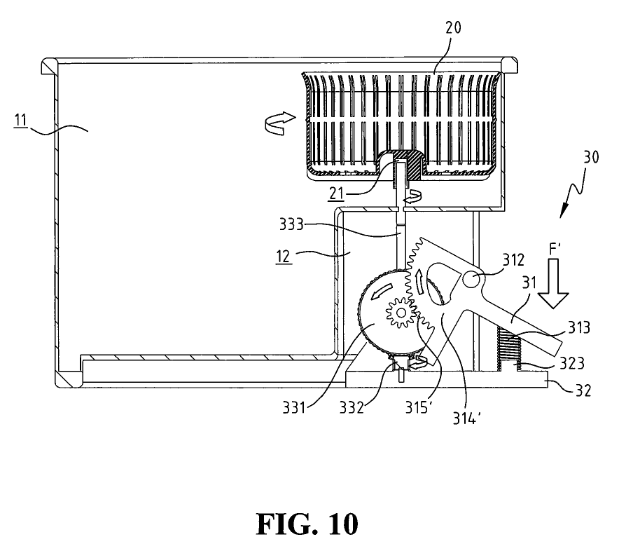

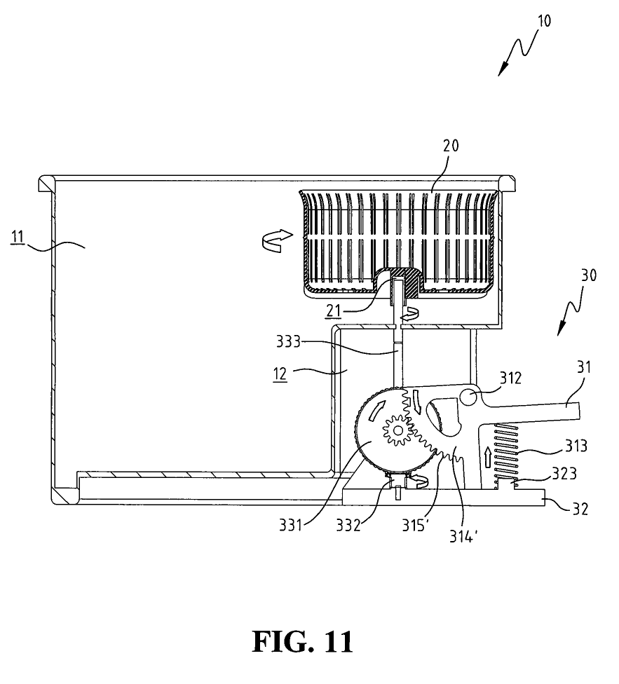

FIG. 9 describes a state of the dewatering structure when there is no external force applied thereto according to a second embodiment of the present invention. FIG. 10 describes an operation state of the dewatering structure when an external force F is applied thereto according to the second embodiment of the present invention. FIG. 11 illustrates a status after releasing the applied external force F according to the second embodiment of the present invention. Referring to FIGS. 9, 10, and 11, the second embodiment is similar to the first embodiment except the fan plate 314′ connected to another end of the operation member 31. The fan plate 314′ is configured with an arcuate gear rack 315′ at an outward surface of the fan plate 314′. The pinion 3311 of the in-line gear disk 331 meshes with the arcuate gear rack 315′, and thus they are driven in linkage with each other.

In operation, the second embodiment is similar to the first embodiment. Referring to FIG. 9, in accordance with a normal state of the dewatering structure, the operation member 31 is propped up and maintained at a high position by the elastic member 313. As shown in FIG. 10, when a user downwardly applies an external force F′ onto the operation member 31, the operation end of the operation member 31 swings pivotally downwardly relative to the pin 312 and thus moves to a low position. Meanwhile, the arcuate gear rack 315′ of the operation member 31 swings upwardly to drive the pinion 3311 and the in-line gear disk 331 to synchronously rotate in counterclockwise direction. Therefore, the in-line gear disk 331 drives the irreversible driving gear disk 332, the transmission shaft 333 and the dewatering unit 20 to rotate in clockwise direction, as shown in FIG. 10. In such a way, as being downwardly compressed by the downwardly swung operation end of the operation member 31, the elastic member 313 accumulates an elastic recovery force. Referring to FIG. 11, when the external force F′ applied to the operation member 31 is released therefrom, the accumulated elastic recovery force then pushes the elastic member 313 up back to the high position. In this case, the operation end of the operation member 31 swings upwardly, while the arcuate gear rack 315′ at the other end of the operation member 31 swings downwardly, thus driving the pinion 3311 and the in-line gear disk 331 to synchronously rotate in clockwise direction. Meanwhile, the in-line gear disk 331 also drives the irreversible driving gear disk 332 to rotate in counterclockwise direction. The irreversible driving gear disk 332 can drive the transmission shaft 333 to rotate in one way (clockwise) only, and therefore the transmission shaft 333 and the dewatering unit 20 remain to rotate in clockwise direction due to its inertia.

In operation, a water contained object (not shown) can be put in the dewatering unit 20. When operated by the aforementioned process, the dewatering unit 20 rotates and generates a centrifugal force applying upon the water contained object. Therefore, the water or the water solution contained in the water contained object can be cast out therefrom along a direction of the centrifugal force. In such a way, the dewatering structure according to the present invention is no need electricity for operation

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A dewatering structure, comprising:
a receptacle body, comprising a receptacle tub and an assembling space, wherein the receptacle tub and the assembling space are partitioned by a water proofing material into two independent spaces;
a dewatering unit, being a hollow bucket allowing fluid flowing therethrough and disposed in the receptacle tub; and
an operation unit, comprising:
an operation member, pivotally connected to a base and being allowed to swing like a teeterboard at the pivotal position thereof as a pivotal axis, wherein an elastic member is provided between the operation member the base for providing an upward elastic force to the operation member, and the operation member is further provided with an arcuate gear rack;
the base, comprising:
at least two supporting seats adapted for pivotally connecting the operation member and allowing the operation member to swing like a teeterboard at the pivotal position thereof as a pivotal axis; and
a supporting bracket; and
a transmission mechanism, comprising:
a gear assembly, comprising an in-line gear disk and an irreversible driving gear disk, wherein the in-line gear disk is pivotally coupled to the supporting bracket of the base, and the in-line gear disk is meshed with the arcuate gear rack of the operation member, and the in-line gear disk is perpendicularly meshed with the irreversible driving gear disk; and
a transmission shaft, assembled to the irreversible driving gear disk and pivotally coupled to the base, wherein an upper end of the transmission shaft is assembled passing through a bottom surface of the receptacle tub and coupled to the dewatering unit.

2. The dewatering structure according to claim 1, wherein the operation member comprises an operation end configured to a treadle shape, the operation member is defined with a pivotal hole and is pivotally coupled to the base by a pin inserted through the pivotal hole so that the operation member is allowed to swing like a teeterboard relative to the pin as a pivotal axis.

3. The dewatering structure according to claim 1, wherein another end of the pivotal hole of the operation member is coupled with a hollow fan plate having an inner arcuate surface configured with an arcuate gear rack meshing with the in-line gear disk.

4. The dewatering structure according to claim 1, wherein another end of the pivotal hole of the operation member is coupled with a fan plate having an outward surface configured with an arcuate gear rack meshing with the in-line gear disk.

5. The dewatering structure according to claim 1, wherein the elastic member of the operation member is a coil spring.

6. The dewatering structure according to claim 1, wherein the base is further provided with a positioning pole for the elastic member sleeved thereon.

7. The dewatering structure according to claim 1, wherein the base is further defined with a shaft hole, and a lower end of the transmission shaft of the transmission mechanism is movably embedded in the shaft hole.
